(19) United States
(12) Patent Application Publication
(10) Pub. No.: US 2024/0037705 A1
(43) Pub. Date: Feb. 1, 2024

(54) METHOD TO REDUCE NUCLEAR RADIATION INDUCED SPECKLING IN VIDEO IMAGES

(71) Applicant: Westinghouse Electric Company LLC, Cranberry Township, PA (US)

(72) Inventor: Lyman J. PETROSKY, Latrobe, PA (US)

(73) Assignee: Westinghouse Electric Company LLC, Cranberry Township, PA (US)

(21) Appl. No.: 17/815,470

(22) Filed: Jul. 27, 2022

(51) Int. Cl. G06T 5/50; H04N 25/683

(52) U.S. Cl. CPC G06T 5/50; H04N 25/683; G06T 2207/20216; G06T 2207/10016

(57) ABSTRACT

Disclosed is a video processor for removing interference due to nuclear radiation. The video processor includes a control circuit configured to receive video data from a camera placed in a nuclear radioactive environment, determine a first image from the video data, calculate a first brightness value at a first pixel in a first pixel location in the first image, determine a second image from the video data, calculate a second brightness value at a second pixel in a second pixel location in the second image, compare the first brightness value to the second brightness value, and update the second image by replacing the second pixel in the second image with the first pixel when the second brightness value is greater than the first brightness value. The first image corresponds to a time before the second image, and the first pixel location and the second pixel location are the same location.

### BACKGROUND

The present disclosure relates to a camera and image interference due to nuclear radiation.

### SUMMARY

In one general aspect, the present disclosure provides a video processor for removing interference due to nuclear radiation. The video processor comprises a control circuit that comprises a memory. The control circuit is configured to receive video data from a camera placed in a nuclear radioactive environment, determine a first image from the video data, calculate a first brightness value at a first pixel in a first pixel location in the first image, and determine a second image from the video data, wherein the first image corresponds to a time before the second image. The control circuit is further configured to calculate a second brightness value at a second pixel in a second pixel location in the second image, wherein the first pixel location and the second pixel location are the same location. The control circuit is further configured to compare the first brightness value to the second brightness value, and update the second image by replacing the second pixel in the second image with the first pixel when the second brightness value is greater than the first brightness value.

In another aspect, the present disclosure provides a video processor for removing interference due to nuclear radiation. The video processor comprises a control circuit that comprises a memory. The control circuit is configured to receive a first image from a camera placed in a nuclear radioactive environment, receive a second image from the camera, wherein the first image corresponds to a time before the second image, calculate first brightness value data for the first image, wherein the first brightness value data comprises the brightness value for each pixel in the first image, and calculate second brightness value data for the second image, wherein the second brightness value data comprises the brightness value for each pixel in the second image. The control circuit is further configured to compare the first brightness data to the second brightness data, wherein the brightness value for each pixel at a pixel location in the first image is compared to the brightness value of the corresponding pixel at the same location in the second image. The control circuit is further configured to update the second image by replacing the pixels in the second image with the corresponding pixels in the first image based on the comparison of the first brightness data to the second brightness data.

In another aspect, the present disclosure provides a video processor for removing interference due to nuclear radiation, comprising a control circuit that comprises a memory, wherein the control circuit is configured to receive video data from a camera placed in a nuclear radioactive environment, receive data indicative of movement of the camera, break the video data into a plurality of sequential images, and filter out interference due to nuclear radiation from each of the plurality of sequential images to form an updated plurality of sequential images. The filtering comprises calculate first brightness value data for a first image, wherein the first brightness value data comprises a brightness value for each pixel in the first image. The filtering further comprises calculate second brightness value data for a second image, wherein the second image occurs sequentially after the first image, and wherein the second brightness value data comprises a brightness value for each pixel in the second image. The filtering further comprises compare the first brightness data to the second brightness data, wherein the brightness value for each pixel in the first image is compared to the brightness value of a pixel located at a corresponding pixel location in the second image. The filtering further comprises update the second image by replacing the pixels in the second image with the corresponding pixels in the first image based on the comparison of the first brightness data to the second brightness data, and calculate updated second brightness value data for the updated second image, wherein the updated second brightness value data comprises a brightness value for each pixel in the updated second image. The filtering further comprises calculate third brightness value data for a third image, wherein the third image occurs sequentially after the second image, and wherein the third brightness value data comprises a brightness value for each pixel in the third image. The filtering further comprises compare the updated second brightness data to the third brightness data, wherein the brightness value for each pixel in the updated second image is compared to the brightness value of a pixel located at a corresponding pixel location in the third image, update the third image by replacing the pixels in the third image with the corresponding pixels in the updated second image based on the comparison of the updated second brightness data to the third brightness data, and combine the plurality of updated images into updated video data.

### BRIEF DESCRIPTION OF THE FIGURES

The novel features of the various aspects are set forth with particularity in the appended claims. The described aspects, however, both as to organization and methods of operation, may be best understood by reference to the following description, taken in conjunction with the accompanying drawings in which:

FIG. 1 is a diagram of a video processing system, according to at least one aspect of the present disclosure.

FIG. 2 is a diagram of an example nuclear radiation environment, according to at least one aspect of the present disclosure.

FIG. 3 is a diagram of some components of an example digital camera, according to at least one aspect of the present disclosure.

FIG. 4 is an image that contains speckling, according to at least one aspect of the present disclosure.

FIG. 5 is the filtered result from filtering the image of FIG. 4, according to at least one aspect of the present disclosure.

FIG. 6 is a diagram for a two frame minimum filtering process to remove interference due to nuclear radiation, according to at least one aspect of the present disclosure.

FIG. 7 is a diagram of the two frame filtering process of FIG. 6 being applied to a video stream, according to at least one aspect of the present disclosure.

FIG. 8 is a diagram of the two frame minimum filtering process being applied to more than two images at once, according to at least one aspect of the present disclosure.

FIG. 9 is an image that contains speckling, according to at least one aspect of the present disclosure.

FIG. 10 is a diagram of an image filtering process to remove interference due to nuclear radiation, according to at least one aspect of the present disclosure.

The accompanying drawings are not intended to be drawn to scale. Corresponding reference characters indicate corresponding parts throughout the several views. For purposes of clarity, not every component may be labeled in every drawing. The exemplifications set out herein illustrate certain embodiments of the invention, in one form, and such exemplifications are not to be construed as limiting the scope of the invention in any manner.

### DESCRIPTION

The video quality of images for inspection and surveillance in areas where a camera is exposed to nuclear ionizing radiation are degraded due to transient bright marks, or speckling, in each video frame. The speckling is due to the effect of the nuclear ionizing radiation (predominately gamma radiation) on the light sensitive elements. Although the presence of individual speckles is transient, their presence degrades the image and makes it difficult to get a clear image. The speckling effect is transient and the affected pixels are randomly distributed in each frame. In addition to being transient, the affected pixels are always biased to yield a brighter output than the correct level for the incident light.

The preferred approach to solve this problem is a digital video filter that outputs the minimum brightness value of each pixel of two or more successive frames thereby excluding the overly bright readings induced by the radiation. A two frame minimum filter can greatly improve the image quality. Using more than the minimum two frames improves the image quality more but at the expense of video responsiveness. The number of frames used in the filter can be tailored dynamically to optimize the viewing based on the camera characteristics and scene activity.

In one instance, a video processor for removing interference due to nuclear radiation, can include a control circuit that comprises a memory. The control circuit can be configured to receive video data from a camera placed in a nuclear radioactive environment, determine a first image from the video data, calculate a first brightness value at a first pixel in a first pixel location in the first image, determine a second image from the video data, wherein the first image corresponds to a time before the second image. The control circuit can be further configured to calculate a second brightness value at a second pixel in a second pixel location in the second image, wherein the first pixel location and the second pixel location are the same location. The control circuit can be further configured to compare the first brightness value to the second brightness value, and update the second image by replacing the second pixel in the second image with the first pixel when the second brightness value is greater than the first brightness value.

A video filter that works by time-averaging successive readings would still produce speckling in the image. The proposed two frame minimum filter is based on the minimum brightness rather than the average value. This process uniquely solves radiation induced pixel errors. An advantage of this approach is that it can be applied with minimum data requirements, is robust, and is not time intensive. The filter can be quickly applied to incoming video, while maintaining a filtered video feed to a user interface for an operator to view in real-time.

Cameras can be used in nuclear radiation fields for numerous applications. For example, inspection applications such as inspecting fuel rods, reactor internals, and reactor equipment are some examples of where a camera transmits images that are degraded by radiation induced speckling. Some additional example locations would be a camera in the vicinity of nuclear reactor contamination for visual inspection, such as in or near piping, vessels, or a nuclear reactor core, or a camera that is close to material that has been activated by prior neutron bombardment, such as spent fuel or waste fuel. An example application for inspection would be remote robotic assist systems for inspection and repair of nuclear reactors. In the instance of operating remote systems, the random speckling in a video feed can be very distracting for an operator. In some instances, the specking can make it difficult for an operator to complete their work.

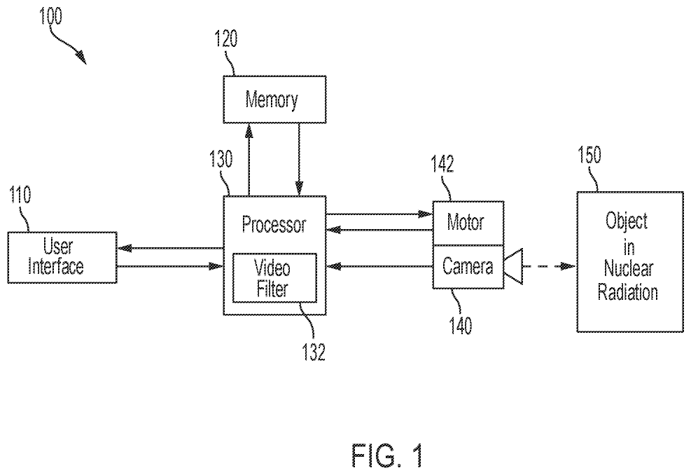

FIG. 1 is a diagram 100 of a camera 140 that is placed in nuclear radiation. The location of the camera 140 in nuclear radiation causes impinging on the camera 140. The camera 140 is recording images and/or video of an object 150 that is in or near nuclear radiation. The camera 140 may be attached to a motor 142 that could allow a user to move the camera 140 to view different aspects of the object 150. For example, the motor 142 could rotate the camera 140. The motor 142 can be communicably coupled to a video processor 130. The video processor 130 could be located separate from the camera 140 or it could be a part of the camera 140 itself. The video processor 130 could relay user inputs from a user interface 110 to control the motor 142. The motor 142 could send data indicative of the camera motion to the video processor 130. The camera 140 can be communicably coupled to the video processor 130. In one instance, the video processor 130 could be internal to a housing of the camera 140. In an alternative instance, the video processor 130 could be external to the camera housing with the camera 140 being either wirelessly coupled to the processor 130 or wired to the processor 130. In either instance, the camera 140 is communicably coupled to the video processor 130 and transmits image data and/or video data to the video processor 130.

The video processor 130 includes a video filter 132. The video filter 132 edits the incoming images and/or video, which can be configured to remove speckling due to the nuclear radiation field that the camera 140 is located within. The processor 130 is communicably coupled to a memory 120. The memory can be used to store instructions for removing the speckling due to nuclear radiation. For example, the memory 120 could store instructions for a two frame minimum filter. The memory 120 can be accessed by the video filter 132 to perform the two frame minimum filter. Additionally, the memory 120 can store the raw data that has speckling, as well as the filtered data that has the speckling removed.

The processor 130 is communicably coupled to the user interface 110. The processor 130 can transmit the raw data and/or the filtered data to the user interface 110. The user interface 110 can include a display that allows a user to review the raw and/or the filtered video data. In an alternative aspect, the display could be separate from the user interface 110. The user interface 110 can allow a user to update the parameters for removing speckling due to nuclear radiation. For example, the user could input parameter adjustments for the two frame minimum filter, such as adjusting the number of frames from two to a value larger than two. This example adjustment would slow video responsiveness but might be needed if the speckling lasts more than two frames. In one instance, the video processor 130 could perform an analysis of a pixel to inform the user how many frames or an amount of time that pixel contained speckling.

The speckling can be due to gamma radiation inducing ionization that causes some pixels in an image frame to randomly brighten. In some instances, a pixel that was randomly brightened may require only 1 frame to settle and no longer be anomalously bright. In some alternative instances, a pixel can require multiple frames before it settles and is no longer anomalously bright. In these instances, a user can input a time or number of frames to perform the two minimum filter across to achieve a desired result of speckling removal from an incoming video feed and/or image.

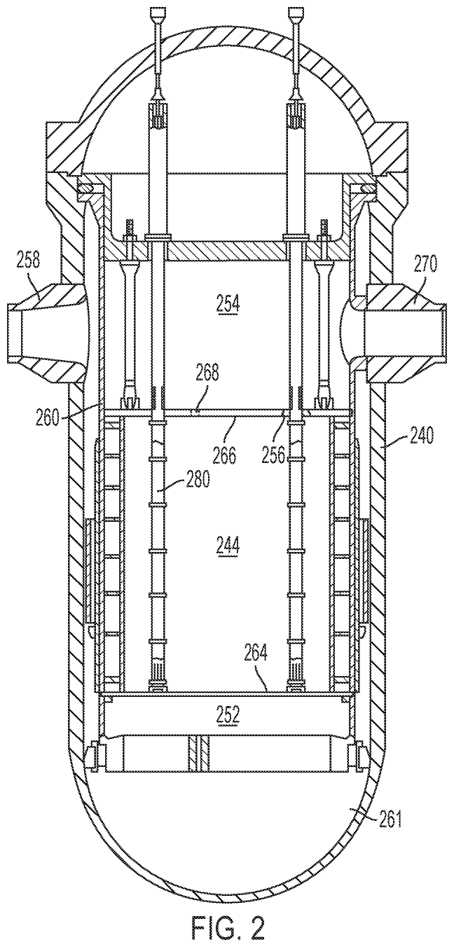

FIG. 2 shows an example nuclear radioactive environment where a camera may be positioned and end up transmitting images and/or video that have been degraded by radiation induced speckling. An example nuclear reactor design is illustrated in FIG. 2 and explained briefly herein. The reactor core 244 comprised of a plurality of parallel, vertical, co-extending fuel assemblies 280, for purpose of this description, the other vessel internal structures can be divided into the lower internals 252 and the upper internals 254. In conventional designs, the lower internals' function is to support, align and guide core components and instrumentation as well direct flow within the vessel. The upper internals 254 restrain or provide a secondary restraint for the fuel assemblies 280 (only two of which are shown for simplicity in this figure), and support and guide instrumentation and components, such as control rods 256. The coolant enters the reactor vessel 240 through one or more inlet nozzles 258, flows down through an annulus between the reactor vessel 240 and the core barrel 260, is turned 180° in a lower reactor vessel plenum 261, passes upwardly through a lower support plate and a lower core plate 264 upon which the fuel assemblies 280 are seated, and through and about the assemblies. Coolant exiting the core 244 flows along the underside of the upper core plate 266 and upwardly and through a plurality of perforations 268 in the upper core plate 266. The coolant then flows upwardly and radially to one or more outlet nozzles 270. A camera could be placed to allow an operator to inspect any of the internal or external components of the nuclear reactor illustrated in FIG. 2. For example, the reactor is de-fueled for inspection, providing a submerged open area in which to place an inspection camera. Even without fuel, the reactor internals are highly radioactive (activated) due to the neutron bombardment during operation, which transmutes some of the structural materials into radioisotopes (e.g., Co-60).

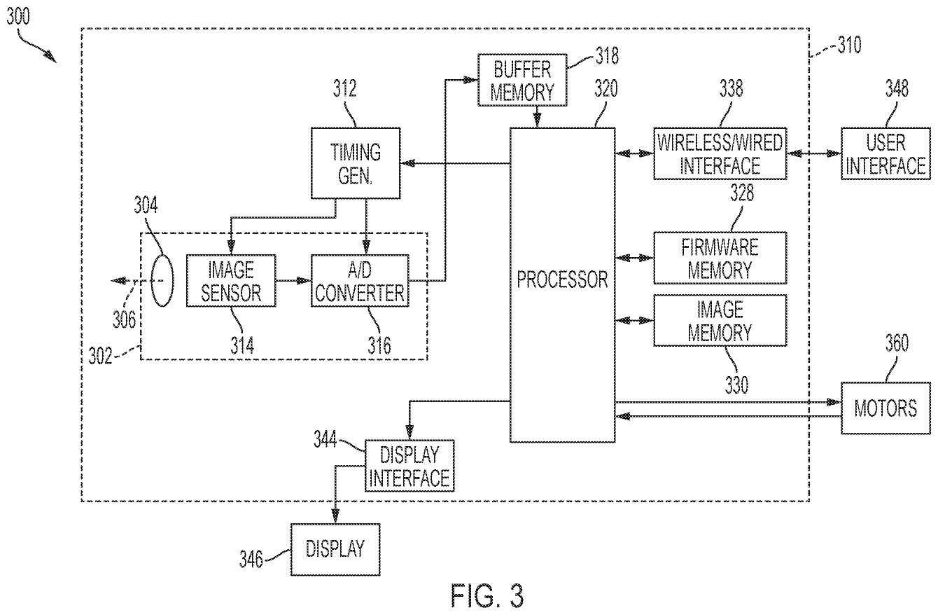

FIG. 3 depicts a block diagram 300 of an example digital camera 310 that could be used as camera 140 in FIG. 1 and the processor 320 could be processor 130 of FIG. 1. The digital camera 310 produces digital images that are stored as digital image files using image memory 330. The phrase “digital image” or “digital image file,” as used herein, refers to any digital image file, such as a digital still image or a digital video file. In some instances, the digital camera 310 captures both motion video images and still images.

In various instances, the digital camera 310 includes an image capture system 302. The image capture system 302 includes an image sensor 314 and an optical system comprising a lens 304 for forming an image of a scene (not shown) onto the image sensor 314, for example, a single-chip color CCD or CMOS image sensor. The image capture system 302 has an optical axis 306 directed outward from the front of the lens 304. In some instances, the lens 304 is a fixed focal length, fixed focus lens. In other instances, the lens 304 is a zoom lens having a focus control and is controlled by zoom and focus motors or actuators (not shown). In some instances, the lens 304 has a fixed lens aperture, and in other instances the lens aperture is controlled by a motor or actuator (not shown). The output of the image sensor 314 is converted to digital form by an Analog-to-Digital (AlD) converter 316, and the digital data is provided to buffer memory 318.

The buffer memory 318 stores the image data from the image capture system 302.

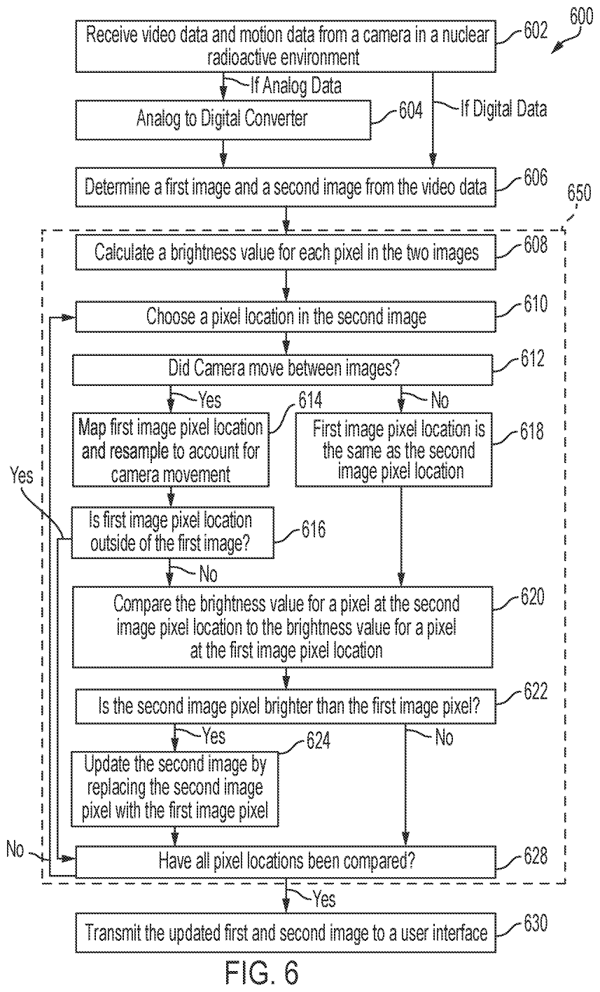

The image data stored in buffer memory 318 can be subsequently manipulated by a processor 320, using embedded software programs (e.g., firmware) stored in firmware memory 328. In some instances, the two frame minimum filter could be stored in the firmware memory 328. In various instances, the processor 320 may be configured to implement a digital filter in accordance with FIGS. 6-8 and 10. In various instances, the user interface 348 can be used to update the software programs stored in firmware memory 328 using a wireless/wired interface 338. The firmware memory 328 can also be used to store image sensor calibration data and user setting selections. In some instances, the processor 320 includes a program memory (not shown), and the software programs stored in the firmware memory 328 are copied into the program memory before being executed by the processor 320.

It will be understood that the functions of processor 320 can be provided using a single programmable processor or by using multiple programmable processors, including one or more digital signal processor (DSP) devices. Alternatively, the processor 320 can be provided by custom circuitry (e.g., by one or more custom integrated circuits (ICs) designed specifically for use in digital cameras), or by a combination of programmable processor(s) and custom circuits. It will be understood that connectors between the processor 320 from some or all of the various components shown in FIG. 3 can be made using a common data bus. For example, in some instances the connection between the processor 320, the buffer memory 318, the image memory 330, and the firmware memory 328 can be made using a common data bus.

Processed images are stored using the image memory 330. It some instances, the raw images can also be stored in the image memory. It is understood that the image memory 330 can be any form of memory known to those skilled in the art.

It will be understood that the image sensor 314, the timing generator 312, and AlD converter 316 can be separately fabricated integrated circuits, or they can be fabricated as a single integrated circuit as is commonly done with CMOS image sensors. In some instances, this single integrated circuit can perform some of the other functions shown in FIG. 3, including some of the functions provided by processor 320.

The image sensor 314 is effective when actuated by timing generator 312 for providing a motion sequence data or still image data. The exposure level is controlled by controlling the exposure periods of the image sensor 314 by way of the timing generator 312, and the gain (i.e., ISO speed) setting of the AlD converters 316. In some instances, the processor 320 also controls one or more illumination systems (not shown), such as an LED, which can be used to selectively illuminate the scene in the direction of optical axis 306, to provide sufficient illumination under low light conditions.

A display interface 344 provides an output signal from the digital camera 310 to a display 346, such as a flat panel HDTV display. Digital video or still digital images may be transmitted through the display interface 344 to the display 346. In various instances, the display 346 is separate from the user interface 348. In some instances, the display 346 and the user interface 348 may be combined into 1 device. The user interface 348 may allow an operator to move the digital camera 310 through motors 360. The user interface 348 transmits commands from an operator through the wireless/wired interface 338 to the processor 320. The processor 320 uses those commands to control the motors 360 to move the camera as desired by the operator. For example, in some instances, the motors 360 can rotate the camera 310 about 2 degrees of freedom (pan and tilt). In certain instances, the motors 360 can move the camera about 6 degrees of freedom (3 rotations and 3 translation). The motor 360 transmits motion data for the motors 360 to the processor 320. The processor 320 can track the movement of the camera 310 from the motion data.

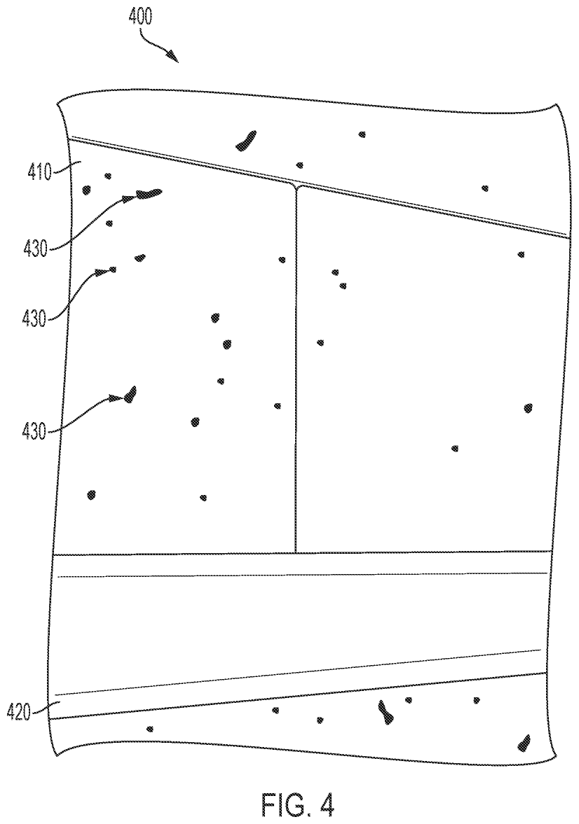

FIG. 4 shows an image 400 from the inside of a test cell, where there is nuclear radiation. The image 400 shows lead blocks 410 sitting on top of a support rail 420. The image 400 has speckling 430 due to the nuclear radiation throughout the image. The image 400 along with a second image of the same scene can be used in the two frame minimum filter to remove the speckling 430. The two frame minimum filter begins by acquiring at least two images. In some instances, the two images are sequential frames from a video. In other instances, the two images could be frames from a video that are not sequential. In yet another instance, the two images could be two still images that are not related to a video. A brightness value for each pixel in, at minimum, two images is determined by a processor. In certain instances, more images can be used however the real time video responsiveness will be reduced the more images used. The pixels in the same pixel location across the two images are compared to each other. The second image pixel is replaced by the first image pixel, if the brightness value of the second pixel is brighter than the first pixel. If the brightness value of the second pixel is not brighter than the first pixel, then the second pixel is not replaced. If there are more than 2 images being used, then the pixel brightness of the pixels in the current pixel location across the images are compared. The pixel with the lowest brightness is placed in the pixel location of the last image in the list. By cycling through each pixel location and performing the same comparison and replacement, the speckling 430 can be removed from image 400.

In some instances, the camera can be moved by a motor between two or more images. The movement of the camera can be accounted for in the two frame minimum filter. The movement of the camera changes the pixel location of the pixels that need to be compared between the images. Stated another way, the first image pixel locations are mapped to the second image pixel locations and first frame pixel values are interpolated (resampled) at the equivalent pixel locations defined by the second image. This allows the pixel brightness comparisons to be for the same location in the two images. If there are more than two images, then the pixel locations for earlier images in the list can be mapped to the pixel locations in the latest (most current) image in the list. This allows the brightness comparison between the images to be based on the movement of the motor between each image. This process allows the camera to move and still compare pixels that are showing the same part of an object being viewed. This allows the two filter minimum process to be applied to a live video stream and account for camera movement.

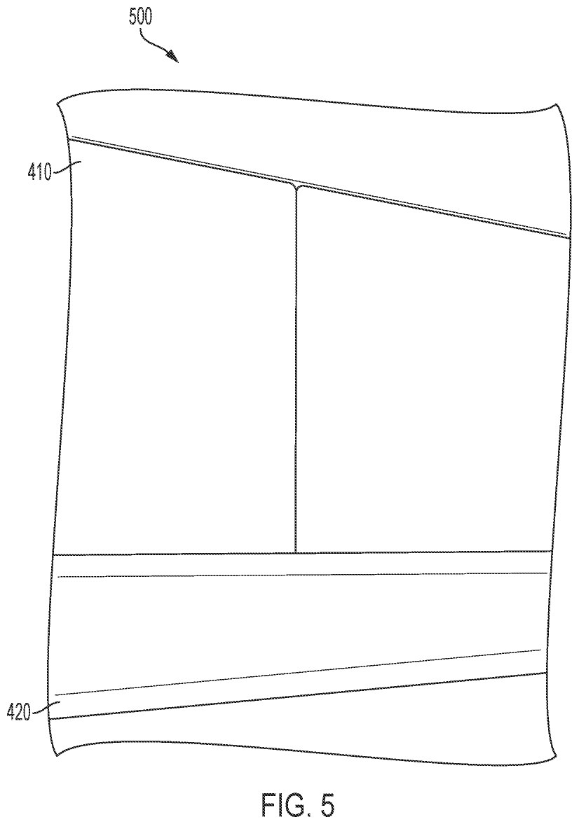

FIG. 5 shows an image 500 that corresponds to an updated/filtered image 400 after the speckling 430 has been removed through the two frame minimum filter. As can be seen from FIG. 5, the simple 2-frame minimum filter greatly improves the image quality; virtually eliminating the speckling 430. In some instances, additional frames may be needed to remove the speckling 430. Using additional frames can improve the image quality but at the expense of video responsiveness. The number of frames used can be tailored dynamically to optimize the viewing based on the camera characteristics and scene activity. In certain instances, the number of frames being used can be input by an operator through the user interface.

A video processor, e.g. the processor 130 or the processor 320, may be configured to implement a digital filter, such as the two frame minimum filter. Various aspects of the digital filter may be implemented in accordance with FIG. 6. FIG. 6 illustrates a diagram 600 showing the two frame minimum filtering process 650 being applied to two images. At step 602, video data and motion data from a camera in a nuclear radioactive environment is received by a video processor. If the video data is analog video data, then the video processor proceeds to step 604, where the analog video data is converted to digital video data, and then proceeds to step 606. If the video data is already digital video data, then the process proceeds directly to step 606. At step 606, two images from the video data are selected by the video processor. In various instances, the two images can occur sequentially in time one after the other. In certain instances, the two images can occur a predetermined time after one another. For example, the video processor can be configured to calculate an amount of time for nuclear radiation interference of a pixel in an image to settle back to its true value. Stated another way, the video processor can determine an amount of time for a pixel that was brightened due to nuclear radiation interference to return to its normal state. In certain instances, a time between the two images can be greater than or equal to the time determined for a pixel to return to its normal state.

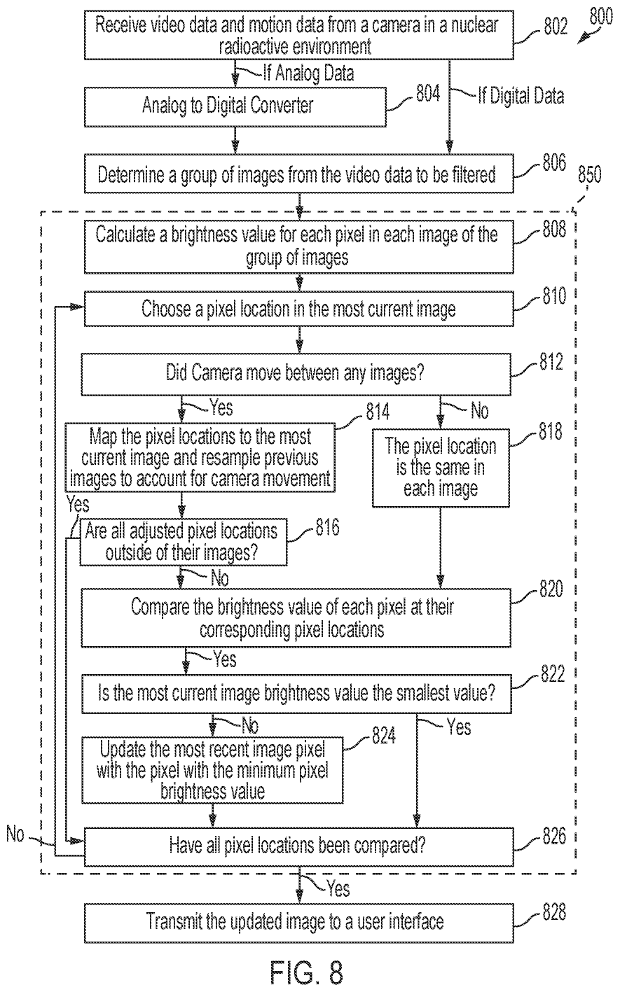

In various instances, a user can use an interface to select between having the images be sequentially in time or have a time gap between the two images based on image quality and desired video responsiveness. In some instances, the video processor can select the time between the images and/or the number of images to use that would to produce a user provided video responsiveness and image quality. For example, a user could input that the video responsiveness needs to be more responsive and the video processor could automatically decrease any gap time between images. The image quality may or may not be affected by the gap time being reduced. To improve image quality, the user could select for the video processor to use more than two image frames in the two frame minimum filter (see 850 FIG. 8). These additional frames could occur sequentially in time or there could be a time gap between these additional frames.

Referring back to FIG. 6, once the two frames are selected, the video processor proceeds to perform the two frame minimum filter process 650 going from step 608 to step 628 and ending once the output image has been filtered. At step 608, the video processor calculates a brightness value for each pixel in the two images. The location of the pixel and the brightness value of the pixel can be recorded together. At step 610, the video processor begins going through all the pixel locations by choosing a pixel location in the second image for comparison against the first image. At step 612, the video processor checks the motion data received by the camera to see if the camera moved between the two images. In various instances, the video data can be timestamped and the motion data can be timestamped, which allows the video processor to calculate if the camera moved between the images. Alternatively, camera motion can be estimated by directly comparing sequential frames by various techniques, such as pixel a based alignment, feature based alignment, Fourier-based alignment etc., to determine image alignment. If the camera did not move between the images, then the video processor proceeds along the “no” branch to step 618. At step 618, the first image pixel location is recorded to be the same as the second pixel image location and the video processor proceeds to step 620.

If the camera moved between the images, then the video processor proceeds along the “yes” branch to step 614. At step 614, the video processor maps the first image pixel locations to the second image pixel locations based on the camera movement. Then the video processor interpolates (resamples) the first frame pixel values at equivalent pixel locations defined by the second image so that a comparison can be made. In some instances, a new pixel brightness value can be calculated for the interpolated first frame pixel value and this new brightness value is used for comparison against the second image pixel brightness value. In some instances, the camera movement could cause the object of the second pixel to be off of the first image, in these instances the video processor cannot make a comparison between the brightness of the first image and the second image. At step 616, the video processor verifies if the camera movement caused the second image pixel location to be outside of the first image. If the second image pixel location is outside of the first image, then a comparison of the pixel brightness between the images cannot be performed and the video processor proceeds along the “yes” branch to step 628. If the second image pixel location is within the first image, then the video processor proceeds along the “no” branch to step 620. Once the pixel location in the first image is known, the video processor proceeds to the comparison step 620.

At step 620, the video processor compares a brightness value for a pixel at the pixel location in the second image to the brightness value of a pixel at the pixel location in the first image. At step 622, the video processor determines if the pixel from the second image is brighter than the pixel from the first image. If the second pixel is brighter than the first pixel, then the video processor proceeds along the “yes” branch to step 624. At step 624, the second image is updated by replacing the pixel at the pixel location in the second image with the pixel at the pixel location in the first image. Then the video processor continues to step 628. If the first pixel is brighter than or the same brightness as the second pixel, then the video processor proceeds along the “no” branch to step 628. Nothing is done to the second image pixel if the first image pixel is brighter than the second image pixel. At step 628, the video processor checks to see if a brightness value for each pixel location in the second image has been compared. If there are still pixel locations in the second image to compare, then the video processor proceeds along the “no” branch to step 610 where the video processor chooses another pixel location and performs steps 612 to 628. The video processor cycles through steps 610 to 628 until all of the pixel locations in the second image have been chosen and compared to the first image. Once all of the pixel locations in the second image have been compared, then the two frame minimum filter process 650 has been completed and the video processor proceeds along the “yes” branch to step 630. At step 630, the updated second image is transmitted to a user interface for an operator to view. The updated second image has the speckling due to nuclear radiation greatly reduced and in some instances completely removed. In various instances, the filtering process can be performed in real-time allowing an operator to view updated images from the camera in real-time.

In some instances, the two frame minimum filter process 650 can update the first image along with the second image. This process would work the same as described with the difference being using the second raw image data to update the first raw image data.

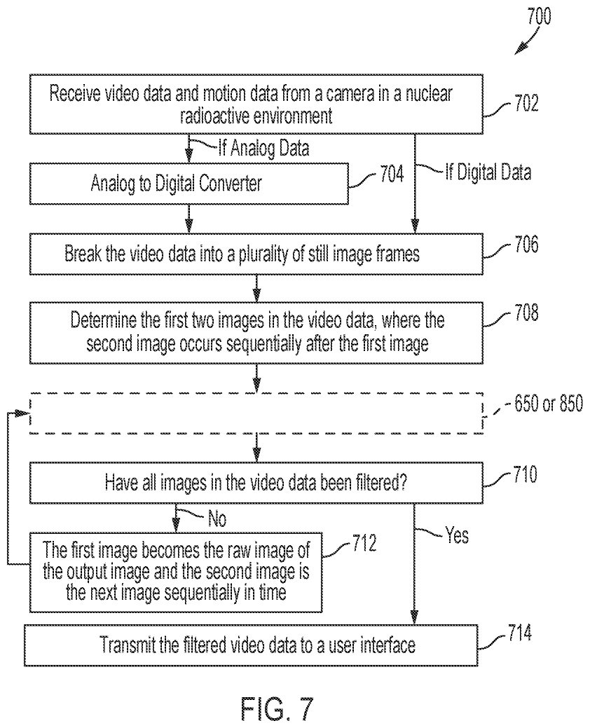

A video processor, e.g. the processor 130 or the processor 320, may be configured to implement a digital filter, such as the two frame minimum filter. Various aspects of the digital filter may be implemented in accordance with FIG. 7. FIG. 7 illustrates a diagram 700 showing the two frame minimum filtering process 650 being applied to all the frames of a video stream. At step 702, video data and motion data from a camera in a nuclear radioactive environment is received by a video processor. If the video data is analog video data, then the video processor proceeds to step 704, where the analog video data is converted to digital video data, and then the video processor proceeds to step 706. If the video data is already digital video data, then the video processor proceeds directly to step 706. At step 706, the video data is broken down into a plurality of digital image frames that make up a section of a live video stream or video file. The digital image frames occur sequentially in time. For example, the first frame begins the video stream, the second frame occurs sequentially after the first, the third frame occurs sequentially after the second, and so on until the final frame ends the video stream.

At step 708, the first two images or frames are selected. The two images are then passed into the two frame minimum filter process 650 described above in reference to FIG. 6. The output of the two frame minimum filter process 650 is the more recent frame after it has been updated by the filtering process. In some instances, more than two images can be selected in step 708 and the number of frames selected is passed into a two frame minimum filter process 850 (FIG. 8). In these instances, the most recent frame in the number of frames that were input into the two frame minimum filter process 850 will be updated and output from the two frame minimum filter process 850. In either case, once the most recent frame has been updated by one of the two frame minimum filter processes 650, 850, the video processor can proceed to step 710. At step 710, the video processor checks if all the images or frames in the video data have been filtered. If all the frames have not been filtered, then the video processor proceeds along the “no” branch to step 712.

At step 712, the video processor proceeds to filter the next frame in the video data. For example, when filtering with only two images, the first image is the previous raw (not updated) second image and the second image becomes the next frame in time that has not entered the filtering process. These two images are then sent into the two frame minimum filter process 650. For example, the first two images of the video data could be sent through the two frame minimum filter process 650. Then the next two images sent through the two frame minimum filter process 650 could be the unfiltered second image and a third image that occurs sequentially in time after the second image. The next images sent through the two frame minimum filter process 650 could be the unfiltered third image and a fourth image that occurs sequentially in time after the third image. This process would continue until all the frames in the video data had been filtered. Stated another way, the video processor will proceed to cycle from step 712 back to 650 until all the images in the video data have gone through the filtering process. Once all the images have gone through the filtering process, the video processor proceeds along the “yes” branch to step 714. At step 714, the video processor transmits the filtered video data to a user interface for an operator to view.

In certain instances, more than two frames can be sent into the two frame minimum filter process, e.g. two frame minimum filter process 850. At step 712, if there are more than two frames being filtered, then the number of next frames input into the two frame minimum filter process 850 shifts by 1 frame in time. For example, if you send in frames 1 through 6 at the same time into the two frame minimum filter process 850, then at step 712 the next frames input into the two frame minimum filter process 850 would be frames 2 through 7. All the frames sent into the two frame minimum filter process 850 are raw, or unfiltered, frames. This process continues until all the video frames have been through the video filtering process. Once all the images have been filtered, the video processor proceeds along the “yes” branch to step 714. At step 714, the video processor transmits the filtered video data to a user interface for an operator to view.

In various instances, the video data can be received by the video processor in real-time. An advantage of the two frame minimum filter processes 650 and 850 are that the video data can be filtered in real-time and transmitted to an operator for viewing. For example, the video processor can receive the video data as a packet of video data in time. The video processor can filter that packet of video data removing any speckling and transmit the updated video data before the video processor receives a new video data packet. This allows updated video data to be streamed to an operator in real-time.

A video processor, e.g. the processor 130 or the processor 320, may be configured to implement a digital filter, such as the two frame minimum filter 850. Various aspects of the digital filter may be implemented in accordance with FIG. 8. FIG. 8 illustrates a diagram 800 showing the two frame minimum filtering process 850 being applied to a plurality of frames at once. The two frame minimum filtering process 850 is substantially similar to the two frame minimum filtering process 650. The main difference between them is that the two frame minimum filtering process 850 can be applied to more than two images at once and the two frame minimum filtering process 650 is applied to only two images at once. For the sake of brevity, not all similarities between the two frame minimum filtering processes 650 and 850 will be described in detail.

At step 802, video data and motion data from a camera in a nuclear radioactive environment is received by a video processor. If the video data is analog video data, then the video processor proceeds to step 804, where the analog video data is converted to digital video data, and then proceeds to step 806. If the video data is already digital video data, then the video processor proceeds directly to step 806. At step 806, a group of images from the video data are selected by the video processor. The group of images can contain more than two images. In various instances, the images in the group can occur sequentially in time. In some alternative instances, the images in the group do not have to occur sequentially in time and could have any kind of time gap between each image in the group. Once a group of images are chosen, the video processor proceeds to perform the two frame minimum filter process 850 going from step 808 to step 828 and ending once all the images in the group have been filtered.

At step 808, the video processor calculates a brightness value for each pixel in each image. The image location of the pixel and the brightness value of the pixel can be recorded together. At step 810, the video processor begins going through all the pixel locations by choosing a pixel location in the most current image for comparison between the images in the group. At step 812, the video processor checks the motion data received by the camera to see if the camera moved between any of the images in the group. In various instances, the video data can be timestamped and the motion data can be timestamped, which allows the video processor to determine if the camera moved between images. If the camera did not move between the images, then the video processor proceeds along the “no” branch to step 818. At step 818, the pixel locations are recorded to be the same across all of the images and the video processor proceeds to step 820.

If the camera moved between the images, then the video processor proceeds along the “yes” branch to step 814. At step 814, the video processor maps the pixel location for each image to the pixel location of the most current image in the group based on the camera movement. Then the video processor interpolates (resamples) each image pixel value at equivalent pixel locations defined by the most current image so that a comparison can be made. In some instances, a new pixel brightness value can be calculated for each interpolated pixel value and this new brightness value is used for comparison against the most current image pixel brightness value. Stated another way, the video processor accounts for the movement of pixel locations in each image, due to the movement of the camera, so that pixel brightness values between the images can be compared. In some instances, the camera movement could cause the object of one of the pixels to be outside its corresponding image, in these instances the video processor cannot make a comparison between that pixel location brightness of that image against the pixel location brightness of the other images in the group. At step 816, the video processor checks that the camera movement did not cause all the adjusted pixel locations to be outside their corresponding images. If all the adjusted pixel locations are outside of their corresponding images, then a comparison of the pixel brightness between the images cannot be performed and the video processor proceeds along the “yes” branch to step 826. If the adjusted pixel locations are within at least some of the images in the group, then the video processor proceeds along the “no” branch to step 820. Once the pixel brightness values at a pixel location and any camera movement is accounted for in the images, the video processor proceeds to the comparison step 820.

At step 820, the video processor compares pixel brightness values corresponding to a pixel brightness at the determined pixel location in each image. In some instances, the camera moved between images and the pixel brightness for a location was calculated based on the movement of the camera as described above. At step 822, the video processor determines if the most recent image has the minimum pixel brightness value. If the most current image has the minim pixel brightness value, then the video processor proceeds along the “yes” branch to step 826. If the is another image in the group with the minimum pixel brightness value, then the video processor proceeds along the “no” branch to step 824. At step 824, the pixel of the most recent image is replaced with the pixel with the minimum brightness value. In some instances, the pixel with the minimum brightness value is generated from interpolation, or resampling, due to movement of the camera. At step 826, the video processor checks to see if a brightness value for each pixel location in the most recent image has been compared. If there are still pixel locations in the most recent image to compare, then the video processor proceeds along the “no” branch to step 810, where the video processor chooses another pixel location and performs steps 812 to 826. The video processor cycles through steps 810 to 826 until all of the pixel locations in the most recent image have been chosen and compared. Once all of the pixel locations have been compared then the two frame minimum filter process 850 has been completed and the video processor proceeds along the “yes” branch to step 828. At step 828, the updated image, which is the filtered most recent image, is transmitted to a user interface for an operator to view. The updated image has the speckling due to nuclear radiation greatly reduced and in some instances completely removed. In various instances, the filtering process can be performed in real-time allowing an operator to view updated images from the camera in real-time.

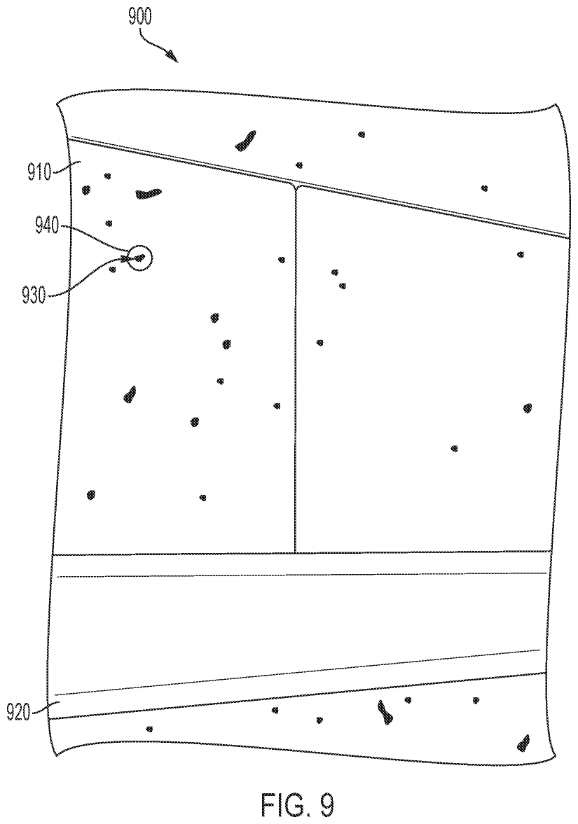

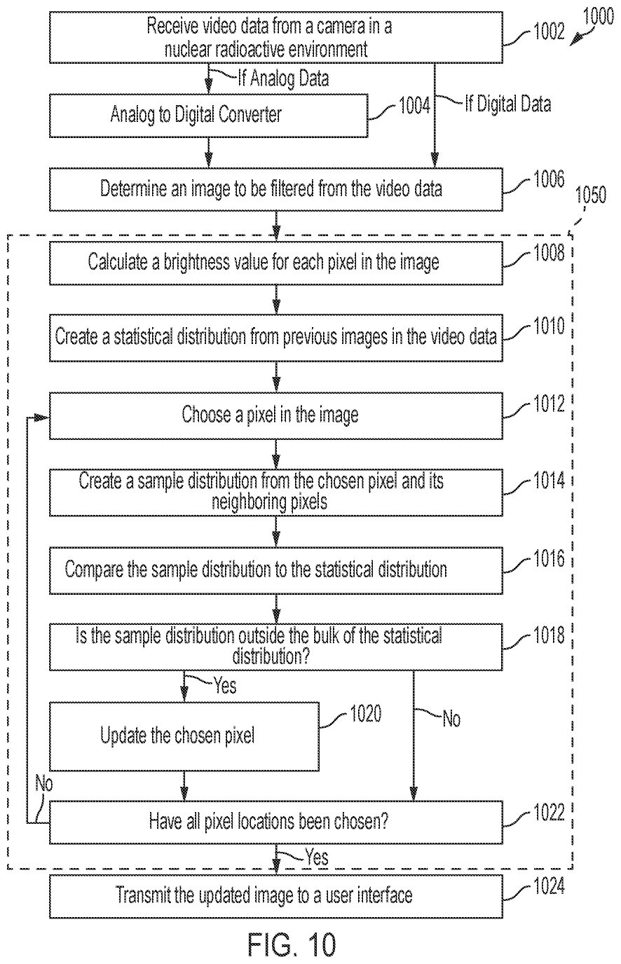

FIGS. 9 and 10 describe an alternative image filtering process to remove speckling due to nuclear radiation. FIG. 9 shows an image from the inside of a test cell, where there is nuclear radiation. The image 900 shows lead blocks 910 sitting on top of a support rail 920. The image 900 has speckling 430 due to the nuclear radiation throughout the image. The filtering process creates a statistical distribution created from a plurality of images through time looking at a single pixel location, such as the pixel location in the middle of circle 940. A sample distribution is gathered from the image. For example, the sample distribution could be generated from the pixels in the circle 940. This sample distribution could include the pixel in center of circle 940 and the pixels surrounding the pixel in the center. The sample distribution is then compared to the statistical distribution. If the sample distribution is outside the bulk of the statistical distribution, then a speckle is most likely located within the same distribution of pixels. For example, the sample distribution could be located outside two standard deviations from the statistical distribution. The speckle could be removed by looking at the distribution in the sample distribution and replacing the pixel with a high pixel brightness value with a pixel close to the average of the sample distribution with that bright pixel removed from the average. In an alternative instance, the average of the statistical distribution could be used to replace the bright pixel. There are a multitude of approaches that can be used to determine a pixel to replace the bright pixel, for example the median of the sample or statistical distribution could also be used. For the sake of brevity, not all approaches are described. In the end, the bright pixel is replaced with a pixel that is near the appropriate value with the brightness due to speckling removed. Each pixel location corresponds to a different statistical distribution and by cycling through each pixel location and creating a sample distribution to compare to the corresponding statistical distribution for that pixel location, the speckles 430 can be identified and removed resulting in an image similar to image 500 of FIG. 5.

A video processor, e.g. the processor 130 or the processor 320, may be configured to implement a digital filter. Various aspects of the digital filter may be implemented in accordance with FIG. 10. FIG. 10 illustrates a diagram 1000 showing a filtering process to remove speckling. At step 1002, video data from a camera in a nuclear radioactive environment is received by a video processor. If the video data is analog video data, then the video processor proceeds to step 1004, where the analog video data is converted to digital video data, and then proceeds to step 1006. If the video data is already digital video data, then the video processor proceeds directly to step 1006. At step 1006, an image from the video data is selected by the video processor. Once the image is chosen, the video processor proceeds to perform the filter process 1050 going from step 1008 to step 1022 and ending once the entire image has been filtered.

At step 1008, the video processor calculates a brightness value for each pixel in the image. At step 1010, the video processor generates a statistical distribution for each pixel location in the image using previously recorded images in the video data that occurred prior to the selected image to be filtered. Stated another way, the video processor generates a statistical distribution for each pixel location in the image using previously recorded images in time. At step 1012, the video processor begins going through each pixel in the image by selecting a first pixel in the image. At step 1014, the video processor generates a sample distribution from the chosen pixel location. The sample distribution could include the pixel at the pixel location chosen and the neighboring pixels. At step 1016, the video processor compares the sample distribution to the statistical distribution. At step 1018, the video processor checks to see if the sample distribution is outside of the bulk of the statistical distribution. For example, the video processor can check to see if the sample distribution is located outside a standard deviation or outside two standard deviations of the statistical distribution. In an alternative instance, at step 1018, the video processor could check to see if the sample distribution is substantially different from the statistical distribution. For example, the statistical distribution could be normally distributed and the sample distribution could be skewed.

If the sample distribution is outside of the statistical distribution, then the video processor proceeds along the “yes” branch to step 1020. At step 1020, the video processor updates the chosen pixel. In various instances, the chosen pixel can be updated by replacing it with a pixel from the sample distribution that is close to the average of the sample distribution after removing the brightest pixels from the sample distribution. In an alternative instance, the average of the pixels in the statistical distribution could be used to replace the chosen pixel. Once the chosen pixel has been updated, the video processor proceeds to step 1022. If the sample distribution is not outside of the statistical distribution, then the video processor proceeds directly from step 1018 to step 1022. At step 1022, the video processor checks to see if all of the pixel locations have been chosen. If there are pixel locations remaining, then the video processor proceeds along the “no” branch to step 1012 and goes through each step until step 1022. This process cycles until all the pixel locations have been chosen. Once all the pixel locations have been chosen, then the video processor proceeds along the “yes” branch to step 1024. At step 1024, the filtered image is transmitted to a user interface for an operator to view. The updated image has the speckling due to nuclear radiation greatly reduced and in some instances completely removed. In various instances, the filtering process can be performed in real-time allowing an operator to view an updated image from the camera in real-time.

### EXAMPLES

Various aspects of the subject matter described herein are set out in the following numbered examples.

Example 1—A video processor for removing interference due to nuclear radiation. The video processor comprises a control circuit that comprises a memory. The control circuit is configured to receive video data from a camera placed in a nuclear radioactive environment, determine a first image from the video data, calculate a first brightness value at a first pixel in a first pixel location in the first image, and determine a second image from the video data, wherein the first image corresponds to a time before the second image. The control circuit is further configured to calculate a second brightness value at a second pixel in a second pixel location in the second image, wherein the first pixel location and the second pixel location are the same location. The control circuit is further configured to compare the first brightness value to the second brightness value, and update the second image by replacing the second pixel in the second image with the first pixel when the second brightness value is greater than the first brightness value.

Example 2—The video processor of Example 1, wherein the control circuit is communicably coupled to a user interface.

Example 3—The video processor of Examples 1 or 2, wherein the video data is analog video data and wherein the control circuit is further configured to convert the analog video data to digital video data.

Example 4—The video processor of Examples 1, 2, or 3, wherein the first image and second image are sequential in time.

Example 5—The video processor of Examples 1, 2, or 3, wherein the first image and second image are not sequential in time, wherein the control circuit is further configured to calculate an amount of time for interference due to nuclear radiation to reduce, and wherein the second image occurs at or after that amount of time after the first image.

Example 6—The video processor of Examples 1, 2, 3, 4, or 5, wherein the control circuit is further configured to determine a brightness value for all remaining pixel locations in the first image and the second image, and update the second image. Updating the second image comprises cycling through each pixel location and comparing the brightness value for a pixel at that location in the second image to the brightness value of a pixel at that location in the first image, and replacing the corresponding pixel in the second image with the pixel from the first image when the brightness value of the pixel in the second image is greater than the pixel in the first image.

Example 7—The video processor of Examples 1, 2, 3, 4, 5, or 6, wherein the control circuit is further configured to transmit the updated second image to a user interface.

Example 8—The video processor of Examples 1, 2, 3, 4, 5, 6, or 7, wherein the control circuit is further configured to calculate a third brightness value at a third pixel in a third pixel location in the updated second image, determine a third image from the video data, wherein the second image corresponds to a time before the third image. The control circuit is further configured to calculate a fourth brightness value at a fourth pixel in a fourth pixel location in the third image, wherein the third pixel location and the fourth pixel location are the same. The control circuit is further configured to compare the third brightness value to the fourth brightness value, and update the third image by replacing the fourth pixel in the third image with the third pixel when the fourth brightness value is greater than the third brightness value.

Example 9—The video processor of Examples 1, 2, 3, 4, 5, 6, 7, or 8, wherein the control circuit is further configured to receive data indicative of movement of the camera, determine movement of the camera between the first image and the second image, and account for movement of the camera between the first image and the second image by adjusting the second pixel location based on the movement of the camera.

Example 10—A video processor for removing interference due to nuclear radiation. The video processor comprises a control circuit that comprises a memory. The control circuit is configured to receive a first image from a camera placed in a nuclear radioactive environment, receive a second image from the camera, wherein the first image corresponds to a time before the second image, calculate first brightness value data for the first image, wherein the first brightness value data comprises the brightness value for each pixel in the first image, and calculate second brightness value data for the second image, wherein the second brightness value data comprises the brightness value for each pixel in the second image. The control circuit is further configured to compare the first brightness data to the second brightness data, wherein the brightness value for each pixel at a pixel location in the first image is compared to the brightness value of the corresponding pixel at the same location in the second image. The control circuit is further configured to update the second image by replacing the pixels in the second image with the corresponding pixels in the first image based on the comparison of the first brightness data to the second brightness data.

Example 11—The video processor of Example 10, wherein replacing the pixels in the second image with the corresponding pixels in the first image comprises cycling through each pixel location in the second image and replacing a pixel in the second image with a pixel in a first image when the brightness value of the pixel in the second image is higher than the brightness value of the pixel in the first image.

Example 12—The video processor of Examples 10 or 11, wherein the control circuit is further configured to transmit the updated second image to a user interface.

Example 13—The video processor of Examples 10, 11, or 12, wherein the first image and second image are sequential in time.

Example 14—The video processor of Examples 10, 11, or 12, wherein the first image and second image are not sequential in time, wherein the control circuit is further configured to determine an amount of time for interference due to nuclear radiation to reduce, and wherein the second image occurs at or after that amount of time after the first image.

Example 15—The video processor of Examples 10, 11, 12, 13, or 14, wherein the control circuit is further configured to receive data indicative of movement of the camera, determine movement of the camera between the first image and the second image, and account for movement of the camera between the first image and the second image by adjusting the second pixel location based on the movement of the camera.

Example 16—A video processor for removing interference due to nuclear radiation, comprising a control circuit that comprises a memory, wherein the control circuit is configured to receive video data from a camera placed in a nuclear radioactive environment, receive data indicative of movement of the camera, break the video data into a plurality of sequential images, and filter out interference due to nuclear radiation from each of the plurality of sequential images to form an updated plurality of sequential images. The filtering comprises calculate first brightness value data for a first image, wherein the first brightness value data comprises a brightness value for each pixel in the first image. The filtering further comprises calculate second brightness value data for a second image, wherein the second image occurs sequentially after the first image, and wherein the second brightness value data comprises a brightness value for each pixel in the second image. The filtering further comprises compare the first brightness data to the second brightness data, wherein the brightness value for each pixel in the first image is compared to the brightness value of a pixel located at a corresponding pixel location in the second image. The filtering further comprises update the second image by replacing the pixels in the second image with the corresponding pixels in the first image based on the comparison of the first brightness data to the second brightness data, and calculate third brightness value data for a third image, wherein the third image occurs sequentially after the second image, and wherein the third brightness value data comprises a brightness value for each pixel in the third image. The filtering further comprises compare the second brightness data to the third brightness data, wherein the brightness value for each pixel in the second image is compared to the brightness value of a pixel located at a corresponding pixel location in the third image, update the third image by replacing the pixels in the third image with the corresponding pixels in the second image based on the comparison of the second brightness data to the third brightness data, and combine the plurality of updated images into updated video data.

Example 17—The video processor of Example 16, wherein the control circuit is further configured to transmit the updated video data to a user interface.

Example 18—The video processor of Examples 16 or 17, wherein the video data is analog video data and wherein the control circuit is further configured to convert the analog video data to digital video data.

Example 19—The video processor of Examples 16, 17, or 18, wherein the control circuit is further configured to receive data indicative of movement of the camera, determine movement of the camera between each of the plurality of sequential images, and account for movement of the camera between each of the plurality of sequential images by adjusting the pixel locations during pixel brightness comparison based on the movement of the camera.

Example 20—The video processor of Examples 16, 17, 18, or 19, wherein the video data is received in real-time and the updated video data is transmitted in real-time with a delay less than the length of a video data packet.

While several forms have been illustrated and described, it is not the intention of Applicant to restrict or limit the scope of the appended claims to such detail. Numerous modifications, variations, changes, substitutions, combinations, and equivalents to those forms may be implemented and will occur to those skilled in the art without departing from the scope of the present disclosure. Moreover, the structure of each element associated with the described forms can be alternatively described as a means for providing the function performed by the element. Also, where materials are disclosed for certain components, other materials may be used. It is therefore to be understood that the foregoing description and the appended claims are intended to cover all such modifications, combinations, and variations as falling within the scope of the disclosed forms. The appended claims are intended to cover all such modifications, variations, changes, substitutions, modifications, and equivalents.

Those skilled in the art will recognize that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flow diagrams are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

It is worthy to note that any reference to “one aspect,” “an aspect,” “an exemplification,” “one exemplification,” and the like means that a particular feature, structure, or characteristic described in connection with the aspect is included in at least one aspect. Thus, appearances of the phrases “in one aspect,” “in an aspect,” “in an exemplification,” and “in one exemplification” in various places throughout the specification are not necessarily all referring to the same aspect. Furthermore, the particular features, structures or characteristics may be combined in any suitable manner in one or more aspects.

Any patent application, patent, non-patent publication, or other disclosure material referred to in this specification and/or listed in any Application Data Sheet is incorporated by reference herein, to the extent that the incorporated materials is not inconsistent herewith. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein will only be incorporated to the extent that no conflict arises between that incorporated material and the existing disclosure material.

In summary, numerous benefits have been described which result from employing the concepts described herein. The foregoing description of the one or more forms has been presented for purposes of illustration and description. It is not intended to be exhaustive or limiting to the precise form disclosed. Modifications or variations are possible in light of the above teachings. The one or more forms were chosen and described in order to illustrate principles and practical application to thereby enable one of ordinary skill in the art to utilize the various forms and with various modifications as are suited to the particular use contemplated. It is intended that the claims submitted herewith define the overall scope.

What is claimed is:

1. A video processor for removing interference due to nuclear radiation, comprising a control circuit that comprises a memory, wherein the control circuit is configured to:
receive video data from a camera placed in a nuclear radioactive environment;
determine a first image from the video data;
calculate a first brightness value at a first pixel in a first pixel location in the first image;
determine a second image from the video data, wherein the first image corresponds to a time before the second image;
calculate a second brightness value at a second pixel in a second pixel location in the second image, wherein the first pixel location and the second pixel location are the same location;
compare the first brightness value to the second brightness value; and
update the second image by replacing the second pixel in the second image with the first pixel when the second brightness value is greater than the first brightness value.

2. The video processor of claim 1, wherein the control circuit is communicably coupled to a user interface.

3. The video processor of claim 1, wherein the video data is analog video data and wherein the control circuit is further configured to convert the analog video data to digital video data.

4. The video processor of claim 1, wherein the first image and second image are sequential in time.

5. The video processor of claim 1, wherein the first image and second image are not sequential in time, wherein the control circuit is further configured to calculate an amount of time for interference due to nuclear radiation to reduce, and wherein the second image occurs at or after that amount of time after the first image.

6. The video processor of claim 1, wherein the control circuit is further configured to:
determine a brightness value for all remaining pixel locations in the first image and the second image; and
update the second image, wherein updating the second image comprises:
cycling through each pixel location and comparing the brightness value for a pixel at that location in the second image to the brightness value of a pixel at that location in the first image; and
replacing the corresponding pixel in the second image with the pixel from the first image when the brightness value of the pixel in the second image is greater than the pixel in the first image.

7. The video processor of claim 6, wherein the control circuit is further configured to:
transmit the updated second image to a user interface.

8. The video processor of claim 1, wherein the control circuit is further configured to:
calculate a third brightness value at a third pixel in a third pixel location in the second image;
determine a third image from the video data, wherein the second image corresponds to a time before the third image;
calculate a fourth brightness value at a fourth pixel in a fourth pixel location in the third image, wherein the third pixel location and the fourth pixel location are the same;
compare the third brightness value to the fourth brightness value; and
update the third image by replacing the fourth pixel in the third image with the third pixel when the fourth brightness value is greater than the third brightness value.

9. The video processor of claim 1, wherein the control circuit is further configured to:
receive data indicative of movement of the camera;
determine movement of the camera between the first image and the second image; and
account for movement of the camera between the first image and the second image by adjusting the second pixel location based on the movement of the camera.

10. A video processor for removing interference due to nuclear radiation, comprising a control circuit that comprises a memory, wherein the control circuit is configured to:
receive a first image from a camera placed in a nuclear radioactive environment receive a second image from the camera, wherein the first image corresponds to a time before the second image;
calculate first brightness value data for the first image, wherein the first brightness value data comprises the brightness value for each pixel in the first image;
calculate second brightness value data for the second image, wherein the second brightness value data comprises the brightness value for each pixel in the second image;
compare the first brightness data to the second brightness data, wherein the brightness value for each pixel at a pixel location in the first image is compared to the brightness value of the corresponding pixel at the same location in the second image; and
update the second image by replacing the pixels in the second image with the corresponding pixels in the first image based on the comparison of the first brightness data to the second brightness data.

11. The video processor of claim 10, wherein replacing the pixels in the second image with the corresponding pixels in the first image comprises cycling through each pixel location in the second image and replacing a pixel in the second image with a pixel in a first image when the brightness value of the pixel in the second image is higher than the brightness value of the pixel in the first image.

12. The video processor of claim 10, wherein the control circuit is further configured to:
transmit the updated second image to a user interface.

13. The video processor of claim 10, wherein the first image and second image are sequential in time.

14. The video processor of claim 10, wherein the first image and second image are not sequential in time, wherein the control circuit is further configured to determine an amount of time for interference due to nuclear radiation to reduce, and wherein the second image occurs at or after that amount of time after the first image.

15. The video processor of claim 10, wherein the control circuit is further configured to:
receive data indicative of movement of the camera;
determine movement of the camera between the first image and the second image; and
account for movement of the camera between the first image and the second image by adjusting the second pixel location based on the movement of the camera.

16. A video processor for removing interference due to nuclear radiation, comprising a control circuit that comprises a memory, wherein the control circuit is configured to:
receive video data from a camera placed in a nuclear radioactive environment;
receive data indicative of movement of the camera;
break the video data into a plurality of sequential images;
filter out interference due to nuclear radiation from each of the plurality of sequential images to form an updated plurality of sequential images, wherein the filtering comprises:
calculate first brightness value data for a first image, wherein the first brightness value data comprises a brightness value for each pixel in the first image;
calculate second brightness value data for a second image, wherein the second image occurs sequentially after the first image, and wherein the second brightness value data comprises a brightness value for each pixel in the second image;
compare the first brightness data to the second brightness data, wherein the brightness value for each pixel in the first image is compared to the brightness value of a pixel located at a corresponding pixel location in the second image;
update the second image by replacing the pixels in the second image with the corresponding pixels in the first image based on the comparison of the first brightness data to the second brightness data;
calculate third brightness value data for a third image, wherein the third image occurs sequentially after the second image, and wherein the third brightness value data comprises a brightness value for each pixel in the third image;
compare the second brightness data to the third brightness data, wherein the brightness value for each pixel in the second image is compared to the brightness value of a pixel located at a corresponding pixel location in the third image;
update the third image by replacing the pixels in the third image with the corresponding pixels in the second image based on the comparison of the second brightness data to the third brightness data; and
combine the plurality of updated images into updated video data.

17. The video processor of claim 16, wherein the control circuit is further configured to:
transmit the updated video data to a user interface.

18. The video processor of claim 16, wherein the video data is analog video data and wherein the control circuit is further configured to convert the analog video data to digital video data.

19. The video processor of claim 16, wherein the control circuit is further configured to:
receive data indicative of movement of the camera;
determine movement of the camera between each of the plurality of sequential images; and
account for movement of the camera between each of the plurality of sequential images by adjusting the pixel locations during pixel brightness comparison based on the movement of the camera.

20. The video processor of claim 16, wherein the video data is received in real-time and the updated video data is transmitted in real-time with a delay less than the length of a video data packet.
